(19) United States
(12) Patent Application Publication
(10) Pub. No.: US 2019/0068912 A1
(43) Pub. Date: Feb. 28, 2019

(54) UNIVERSAL TELEVISION REMOTE CONTROL DEVICE WITH TIMER

(71) Applicant: Ron Johnson, Jefferson, LA (US)

(72) Inventor: Ron Johnson, Jefferson, LA (US)

(21) Appl. No.: 16/115,546

(22) Filed: Aug. 28, 2018

Related U.S. Application Data
(60) Provisional application No. 62/551,173, filed on Aug. 28, 2017.

(51) Int. Cl. H04N 5/60; H04N 5/44

(52) U.S. Cl. CPC H04N 5/60; H04N 2005/4428; H04N 2005/4435; H04N 5/4403

(57) ABSTRACT

A television remote control device having a communicator configured to wirelessly communicate with a media device to send a mute signal and an unmute signal to the media device, to mute the media device for a predetermined time period, is disclosed. The device includes countdown timer for muting a television for a predetermined time period, such as 30, 60, or 90 seconds, which may be used, for instance, to mute commercials. A timer set button is configured to receive a mute command from the user and actuate the communicator to send the mute signal to mute the media device. A countdown timer is electronically connected to the communicator, and the communicator is configured to send an unmute signal to the media device upon expiration of the predetermined time period. A display screen is configured to display the counting down of time of the predetermined period.

This application claims the benefit of U.S. Provisional Patent Application No. 62/551,173, filed on Aug. 28, 2017, the disclosure and contents of which are hereby incorporated by reference herein.

### BACKGROUND OF THE INVENTION

### Field of the Invention

The present invention relates generally to a remote control for media devices and more particularly relates to a hand-held television remote control device with IR/RF transmitter for muting a television.

### Description of the Related Art

Commercials are often significantly louder than most television programs. Commercials can also be annoying to the viewer. Thus, with the growing inconsistency in volume, the need to mute commercials have increased. Over the years, remotes have included mute buttons. However, these devices do not unmute the television after a predetermined time period, which can be set to be approximate to the length of a commercial.

U.S. Pat. No. 6,169,807 issued to Sansur discloses a remote automatic control device. An automatic audio level control device for adjusting the audio level of an appliance in response to changes in ambient sound levels. A microprocessor monitors the ambient sound produced by an audio appliance using a microphone to determine average low and high audio thresholds. When the ambient sound level is outside the threshold range, the microprocessor transmits volume control signals using infrared emitter to the audio appliance to sustain a user-defined average audio level. While a programmable remote is disclosed, the remote is directed at adjusting volume due to ambient noise rather than temporarily muting and then automatically unmuting a media device.

U.S. Pat. No. 9,529,565 issued to Bae et al. discloses a remote control apparatus, method and multimedia system for volume control. A remote control is configured to control volume of a media unit and an external devices simultaneously or consecutively. While a programmable remote is disclosed, the remote is directed at adjusting volume across multiple devices simultaneous rather than temporarily muting and then automatically unmuting a media device.

While these units may be suitable for the particular purpose employed, they would not be as suitable for the purposes of the present invention as disclosed hereafter.

Accordingly, there is a need for an apparatus for selectively muting and automatically unmuting a media device in an effective manner.

As disclosed in this application, the inventor has discovered novel and unique devices and methods as defined in the annexed claims for efficient muting and automatically unmuting a media device, which exhibit superlative properties without being dependent on heavy, immobile, expensive or complex components.

### SUMMARY OF THE INVENTION

It is one prospect of the present invention to provide one or more novel devices of simple but effective construction which can be applied to many environments to efficiently and effectively mute and unmute a media device.

The following presents a simplified summary of the present disclosure in a simplified form as a prelude to the more detailed description that is presented herein.

Therefore, in accordance with embodiments of the invention, a television remote control device is provided, comprising a communicator configured to wirelessly communicate with a media device. The communicator is preferably configured to send a mute signal to mute the media device for a predetermined time period, at the option of the user, upon receiving a mute command from a user. Preferably, the predetermined time period is determined by the user. The communicator is preferably configured to send an unmute signal to unmute the media device upon expiration of the predetermined time period.

In a preferred embodiment, a timer is electronically connected to the communicator and is configured for counting down of time until an expiration of the predetermined time period. Preferably, the timer set button is electronically connected to the communicator and timer. The timer set button is configured to receive the mute command from the user upon a first depression of the timer set button to actuate the communicator to send the mute signal to mute the media device upon the first depression of the timer set button. The first depression of the timer set button preferably initiates counting down of time until the expiration of the predetermined time period, and the expiration actuates the communicator to send an unmute signal to unmute the media device upon the expiration of the predetermined time period.

A display screen is preferably configured to display the counting down of time of the predetermined period.

In one embodiment, the remote control device further comprises volume control buttons.

In another embodiment, the remote control device further comprises a power button configured to turn the media device on and off.

In one embodiment, the media device is a television. In another embodiment, the media device is a home entertainment system.

In one embodiment, wherein the wireless communication is infrared. In another embodiment, wherein the wireless communication is radio frequency.

In yet another embodiment, a method for temporarily muting a media device is disclosed, comprising receiving a mute command from a user upon the user depressing a timer set button. The timer set button is preferably electronically connected to a communicator and a timer. The timer set button is preferably configured to receive the mute command from the user upon a first depression of said timer set button to actuate the communicator to send a mute signal to mute the media device upon the first depression of the timer set button. Upon the user depressing the timer set button, the depressing of the timer set button actuates sending the mute signal to mute the media device for a predetermined time period via the communicator. The communicator is preferably configured to wirelessly communicate with a media device to send the mute signal to mute the media device for a predetermined time period upon receiving the mute command from a user. The communicator is also preferably configured to automatically send an unmute signal to unmute the media device upon expiration of the predetermined time period.

Upon the user depressing the timer set button, the depressing of the timer set button actuates a timer electronically connected to the communicator. The timer is preferably configured for counting down of time until an expiration of the predetermined time period upon the pressing of the timer set button, wherein the first depression of the timer set button by the user initiates counting down of time until the expiration of the predetermined time period. Preferably, the method includes displaying the remaining time of the countdown timer on a display screen on the remote control. Upon expiration of the predetermined time period, the method includes automatically sending a wireless unmute signal to the media device via the communicator to unmute the volume of the media device.

In a preferred embodiment, the predetermined time period is 30 seconds. In yet another embodiment, the predetermined time period is 60 seconds. In yet another embodiment, the predetermined time period is 90 seconds.

In one embodiment, pressing the timer set button twice within one second of time will double the predetermined time period.

In another embodiment, pressing the timer set button three times within one second of tme will triple the predetermined time period.

In one embodiment, pressing the timer set button after the initiation of the predetermined time period will interrupt the predetermined time period and automatically send a wireless un unmute signal to the media device via the communicator to unmute the volume of the device.

In one embodiment, the wireless communication is infrared. In another embodiment, the wireless communication is radio frequency.

These and other features, aspects, and advantages of the present invention will become better understood with reference to the following description and appended claims.

### BRIEF DESCRIPTION OF THE DRAWINGS

Illustrative embodiments of the present invention are described herein with reference to the accompanying drawings, in which like numerals throughout the figures identify substantially similar components, in which:

FIG. 1 is a top plan view of a remote control device in accordance with embodiments of the invention;

FIG. 2 is a flow chart of an exemplary method in accordance with embodiments of the invention;

FIG. 3 is a side elevation view of an exemplary user using the remote control with a media device, in accordance with embodiments of the invention;

FIG. 4 is a flow chart of an exemplary method in accordance with embodiments of the invention; and

FIG. 5 is an exemplary instruction manual illustrating use of the device in accordance with embodiments of the invention.

### DETAILED DESCRIPTION

For a further understanding of the nature and function of the embodiments, reference should be made to the following detailed description. Detailed descriptions of the embodiments are provided herein, as well as, the best mode of carrying out and employing the present invention. It will be readily appreciated that the embodiments are well adapted to carry out and obtain the ends and features mentioned as well as those inherent herein. It is to be understood, however, that the present invention may be embodied in various forms. Therefore, persons of ordinary skill in the art will realize that the following disclosure is illustrative only and not in any way limiting, as the specific details disclosed herein provide a basis for the claims and a representative basis for teaching to employ the present invention in virtually any appropriately detailed system, structure or manner. It should be understood that the devices, materials, methods, procedures, and techniques described herein are presently representative of various embodiments. Other embodiments of the disclosure will readily suggest themselves to such skilled persons having the benefit of this disclosure.

As used herein, “axis” means a real or imaginary straight line about which a three-dimensional body is symmetrical. A “vertical axis” means an axis perpendicular to the ground (or put another way, an axis extending upwardly and downwardly). A “horizontal axis” means an axis parallel to the ground.

As used herein, homogeneous is defined as the same in all locations, and a homogeneous material is a material of uniform composition throughout that cannot be mechanically separated into different materials. Examples of “homogeneous materials” are certain types of plastics, ceramics, glass, metals, alloys, paper, board, resins, high-density polyethylene and rubber.

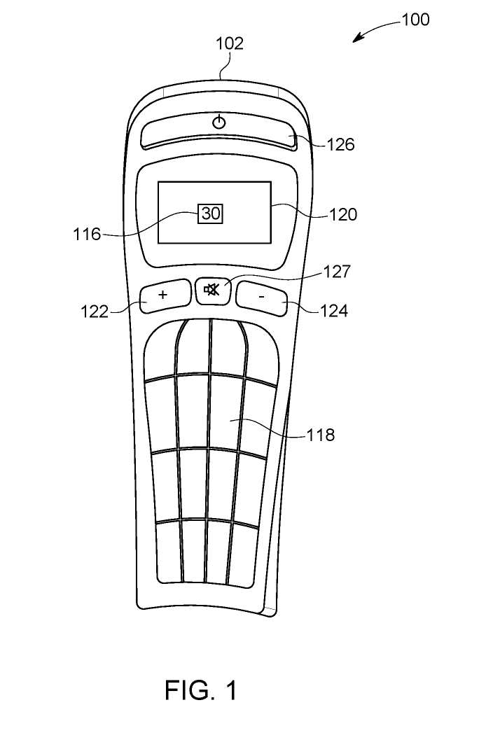

It is one prospect of the present invention to provide one or more novel devices of simple but effective construction which can be applied to temporarily muting a media device upon the command of a user. Referring initially to FIGS. 1-3, the basic constructional details and principles of operation of one embodiment of television remote control 100 according to a preferred embodiment of the present invention will be discussed. Therefore, in accordance with embodiments of the invention, a television remote control device 100 is provided, preferably including a communicator 102 configured to wirelessly communicate with a media device 104. The communicator 102 may be configured to send a mute signal 106 to mute the media device 104 for a predetermined time period 108 upon receiving a mute command 110 from a user 112. The communicator 102 may be further configured to send an unmute signal 114 to unmute the media device 104 upon expiration of the predetermined time period 108.

A timer 116 is preferably electronically connected to the communicator 102 and is configured for counting down of time until an expiration of the predetermined time period 108. Preferably, a timer set button 118 may be electronically connected to the communicator 102 and the timer 114. The timer set button 118 may be configured to receive the mute command from the user 112 upon a first depression of the timer set button 118 to actuate the communicator 102 to send the mute signal 106 to mute the media device 104 upon the first depression of the timer set button 118. In one embodiment, one second of time passes after a first depression of the timer set button 118 before the communicator 102 sends the mute signal 106 to mute the media device 104. In such embodiment, the communicator 102 sends the mute signal 102 one second of time after the first depression, so as to ensure there is not a second depression of the timer set button 118 intended by the user. In one embodiment, the first depression of the timer set button 118 is also deemed a last depression of the timer set button 118, which initiates counting down of time until the expiration of the predetermined time period 108 and the expiration actuates the communicator 102 to send the unmute signal 114 to unmute the media device 104 upon the expiration of the predetermined time period 108, when, for instance, a user does not depress the timer set button 118 a second time within one second of time of the first depression. Preferably, the first depression of the timer set button 118 preferably initiates counting down of time until the expiration of the predetermined time period 108 and the expiration actuates the communicator 102 to send the unmute signal 114 to unmute the media device 104 upon the expiration of the predetermined time period 108.

A display screen 120 may be configured to display the counting down of time of the predetermined period 108.

In one embodiment, the remote control 100 further comprises volume control buttons, such as a volume up button 122 and a volume down button 124. A mute button 127 may also be included. Mute button 127 may be programmed to mute the media device without initiating a predetermined time period. In this embodiment, the mute button 127 may mute the media device 104 until it is pressed again to unmute the media device 104. In an alternative embodiment, a depression of the timer set button 118 while the media device is muted via mute button 127 starts the predetermined time period 108. Upon expiration of the predetermined time period 108, the unmute signal 114 will be automatically sent to the media device 104, without any further action being required of the user 112.

In an embodiment, the remote control may further include a power button 126 configured to turn the media device 104 on and off. The media device 104 may be any type of entertainment device, such as a television, radio, home entertainment system, or the like. Wireless communication via communicator 102 may be any suitable communication method that may be used between the remote 100 and the media device 104, such as infrared and radio frequency, for example.

In yet another embodiment, a method for temporarily muting a media device 128 is disclosed, including receiving a mute command 110 from a user 112 upon the user 112 depressing a timer set button 118. The timer set button 118 is preferably electronically connected to a communicator 102 and a timer 116. The timer set button 118 is preferably configured to receive the mute command 110 from the user 112 upon a first depression of said timer set button 118 to actuate the communicator 102 to send a mute signal 106 to mute the media device 104 upon the first depression of the timer set button 118. Upon the user 112 depressing the timer set button 118, the depressing of the timer set button 118 actuates sending the mute signal 106 to mute the media device 104 for a predetermined time period 108 via the communicator 102. In some embodiments, the device waits one second of time after a first depression of the timer set button 118 before the communicator 102 sends the mute signal 106 to mute the media device 104. In such embodiments, the device is waiting such one second of time so as to ensure there is not a second depression of the timer set button 118 intended by the user prior to the communicator sending the mute signal to the media device 104. The communicator 102 is preferably configured to wirelessly communicate with a media device 104 to send the mute signal 106 to mute the media device 104 for a predetermined time period 108 upon receiving the mute command 110 from a user 112. The communicator 102 is also preferably configured to automatically send an unmute signal 114 to unmute the media device 104 upon expiration of the predetermined time period 108.

Upon the user 112 depressing the timer set button 118, the depressing of the timer set button 118 actuates a timer 116 electronically connected to the communicator 102. The timer 116 is preferably configured for counting down of time until an expiration of the predetermined time period 108 upon the pressing of the timer set button 118, wherein the first depression of the timer set button 118 by the user 112 initiates counting down of time until the expiration of the predetermined time period 108. Preferably, the method 200 includes displaying the remaining time of the countdown timer 116 on a display screen 120 on the remote control 100. Upon expiration of the predetermined time period 108, the method 200 preferably includes automatically sending a wireless unmute signal 114 to the media device 104 via the communicator 102 to unmute the volume of the media device 104.

The predetermined time period 108 may be set for any duration useful for an intended embodiment. For use with muting television commercials, the predetermined time period 108 is preferably 30 seconds, 60 seconds, 90 seconds, 120 seconds, 150 seconds, 180 seconds, 210 seconds, or 240 seconds, which time periods are equal in length to the duration of many commercials. In one embodiment, pressing the timer set button 118 twice within one second of time (i.e., each depression not being more than one second from the last) will double the predetermined time period 108. In another embodiment, pressing the timer set button 118 three times within one second of time will triple the predetermined time period 108.

In an embodiment, pressing the timer set button 118 after the initiation of the predetermined time period 108 will interrupt the predetermined time period 108 and automatically send a wireless unmute signal 114 to the media device 104 via the communicator 102 to unmute the volume of the media device 104. In certain applications, the interrupt and unmute operation may be set to begin after one second of the last time increment addition (i.e., set to begin more than one second after the first depression of the timer set button 118) in order to allow for multiplying the predetermined time period 108 by depressing the timer set button 118 multiple times within the first second to achieve a longer total increment of time equal to a multiple of the predetermined time period 108, but then also allowing a subsequent depression of the timer set button 118 after one second has passed to unmute the media device 104.

Any suitable form of wireless communication such as infrared or radio frequency, for example, may be used to connect the remote 100 with the media device 104.

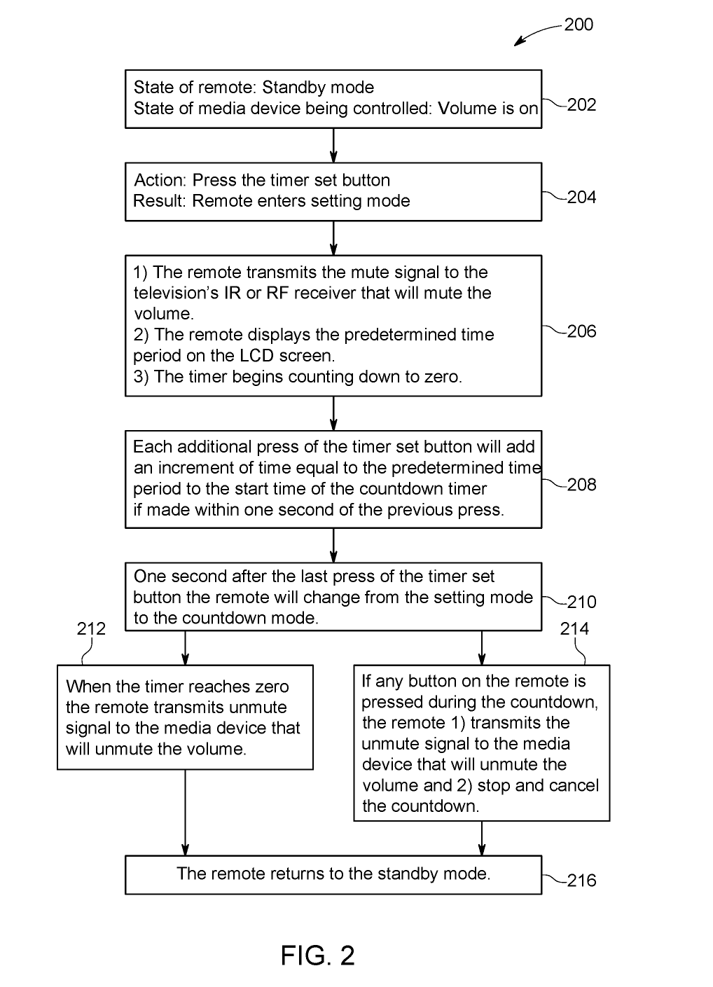

Referring to FIG. 2, a flow chart 200 shows an exemplary set of operations for the invention disclosed herein. Step 202 shows the state of the remote 100 in standby mode 130 and the state of the media device 104 being controlled with the volume on. Step 204 shows an action to press the timer set button 118 and the remote will enter a setting mode 132. In step 206, the remote 100 transmits the mute signal to the infrared or radio frequency receiver 134 of the media device 104 that will mute the volume. Display screen 120 will preferably display the predetermined time period 108 and the timer 116 begins counting down to zero. In step 208, each additional press of the timer set button 118 will add an increment of time equal to the predetermined time period 108 to the start time of the countdown timer 116 if made within one second of the previous press. In step 210, one second after the last press of the timer set button 118, the remote will change from setting mode to a countdown mode 136. In step 212, when the timer 116 reaches zero, the remote 100 will transmit the unmute signal 114 to the media device to unmute the volume. In step 214, if any button on the remote 100 is pressed during the countdown the remote 100 will transmit the unmute signal to the media device 104 that will unmute the volume and stop the countdown timer 116. In step 216, the remote 100 returns to standby mode 130.

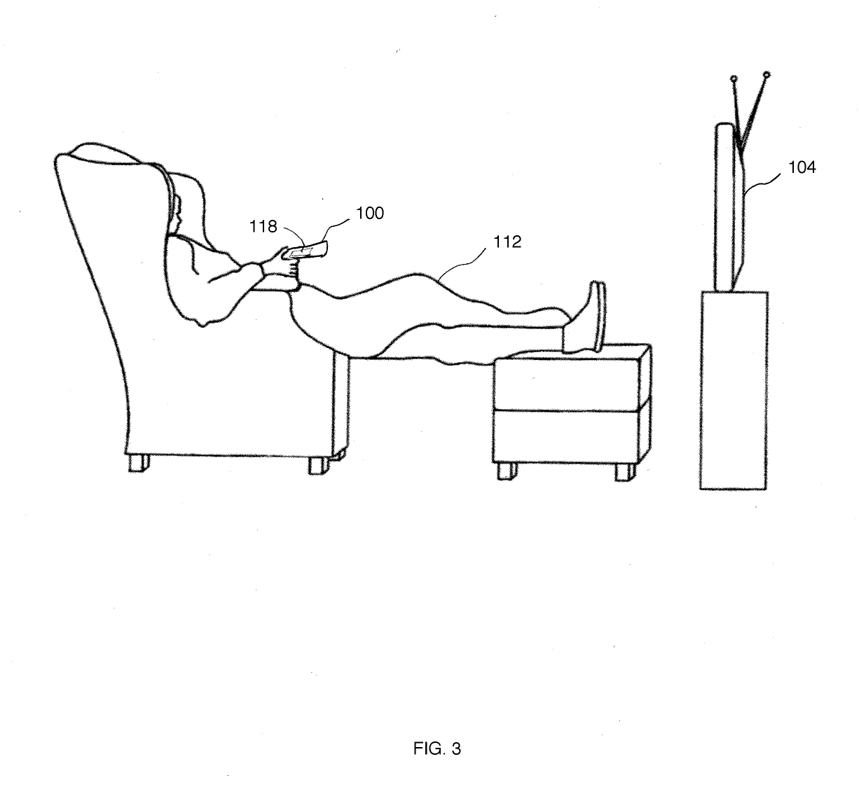

FIG. 3 shows an exemplary setup of a user 112 using the remote 100 in conjunction with a media device 104, such as a television. As illustrated in FIG. 3, timer set button 118 is easily accessible to user 112 due to the large size of timer set button 118. And the communicator 102 is preferably configured to wirelessly communicate with the television 104 to send the mute signal 106 to mute the television 104 for a predetermined time period 108, such as, for example, 30 seconds, upon receiving the mute command 110 from the user 112. In a preferred embodment, the communicator 102 is configured to automatically send an unmute signal 114 to unmute the television 104 upon the expiration of the predetermined time period 108, obviating the need for the user to press, and/or to remember to press, any additional button in order to unmute the television.

In one embodiment of the invention, a universal handheld remote control device 100 with an IR or RF transmitter 102 and countdown timer 116 is provided. In one embodiment, the apparatus 100 is preferably a handheld remote control with an infrared or radio frequency transmitter 102, a display screen 120, microprocessor 138, circuitry 140, button panel 142, and a countdown timer 116, that is preferably configured to automatically transmit a mute signal 106 or an unmute signal 114 to the paired media device 104 at a time in the future determined by the user 112.

In an exemplary embodiment, the remote 100 may be used with one or more media devices 104, such a TV, soundbar, or home theatre, for example. When the user 112 enters a desired time to mute the media device 104, the mute signal 106 is transmitted to the media device 104 via communicator 102 and the timer 116 counts down to zero, at which time the remote 100 automatically sends the unmute signal 114 (to restore audio) to the media device 104, such as a TV receiver. In some embodiments, the remote 100 may be configured to control the on/off, and other functions of the TV, cable box, digital receiver, or other electronic devices used in the TV, communication, or other industries such as HVAC that have equipment that is controlled by “on if off or off if on” IR or RF (toggle) commands. The remote 100 may be programmed to work on any TV or other compatible equipment by entering the manufacturers codes into the remote 100 or by the remote 100 learning the code from the equipment's remote control, for example. An objective of the remote 100 is to allow the user 112 to use the built-in countdown timer to control how long the media device 104 stays muted after the user 112 has depressed the timer set button 118 on the remote 100 to activate the mute function that is built into the media device 104, or how long a toggle-controlled feature of any compatible equipment stays in the on or off state after it was set by the remote 100.

In an embodiment, a handheld IR or RF universal television remote control device 100 may include an integrated timer 114 with countdown functionality with a display 120, such as an LCD screen, that displays the start time and the time remaining after the initiation of a predetermined time period 108.

In one embodiment, a timer set button 118 includes an on/auto off and off/auto on feature that when pressed causes four events to happen simultaneously or within one second or within seven seconds. The remote 100 device transmits a mute signal 106 to command to the media device 104 such as a TV, soundbar or home theater or other equipment being controlled, for example. Next, an add increment of time feature starts and adds a single or multiple time predetermined time period 108 into the starting point of the timer 116 and displays the remaining time on the display screen 120. Further, the timer 116 starts counting down to zero and displays the remaining time on the display screen 120. In one embodiment, upon expiration of the predetermined time period 108, a communicator sends the unmute signal 114 to the controlled media device 104 at a time in the future equal to the total time entered into the timer, such as the predetermined time period 108. An advantage of the invention disclosed herein is the ability to stop and cancel the countdown and immediately transmit the unmute signal 106 to the controlled equipment restoring the volume by depressing the timer set button 118. Typical industry standard software and circuitry are used to control and build all aspects of the remote 100, including the timer 116, the display 120, the timer set button 118, and the IR or RF transmission of the learned or programmed codes for the media device 104 being controlled.

In one embodiment, a method 144 preferably includes transmitting a toggle command, such an unmute signal 114, for example, to unmute a media device 104, such as a TV IR of RF receiver, at a time in the future, such as a predetermined time period 108, can be accomplished by the use of a stationary handheld IR or RF universal remote control 100 which preferably has an integrated timer 116 with count down functionality and a display 120 displaying the time remaining during a predetermined time period 108. The method 144 may include actuating one or more functions such as a mute function or auto unmute function, an on/auto off function, or an off auto on function, programmed into the remote 100 by depressing the timer set button 118 on the remote 100 when the volume of the media device 104 is on. When the timer set button 118 is depressed by the user 112, an exemplary set of four actions happen simultaneously, or within one second of time. First, the mute signal 110 or unmute signal 114 command is sent to the media device, such as a TV or an IR or RF, and a toggle command is transmitted to the IR or RF receiver of the media device 104, turning the media device 104 off if it is on or on if it is off. Next, an add increments of time function adds a single predetermined time period 108, such as an increment usually 30 seconds or multiple increments of time into the starting point of the timer 114, and displays the total time entered on display 120. Next, the timer 116 immediately starts counting down to zero. The time remaining shows on the display 120. Finally, a sequence is started that transmits the either a mute signal 106 or an unmute signal 114 toggle command to the controlled media device 104 at a time equal to the total time entered into the timer 116.

In one embodiment, the amount of time set by the user 112 is determined by how many times the user pushes the timer set button 118. For example, one press (i.e., depression) of the timer set button 118 by the user starts the count down from one predetermined time period 108, such as, preferably 30 seconds, for example. Two quick presses of the timer set button 118 by the user start the timer counting down from twice of the chosen predetermined time period 108, such as, preferably 60 seconds, for example. Three, four, five, or more presses of the timer set button 118 increases the amount of time by a multiple of the number of presses before the device transmits the toggle command to send the unmute signal 114. At any time during the countdown, when timer set button 118 is pressed one time a unmute signal 114 is transmitted, which returns volume and the countdown timer 116 returns to standby.

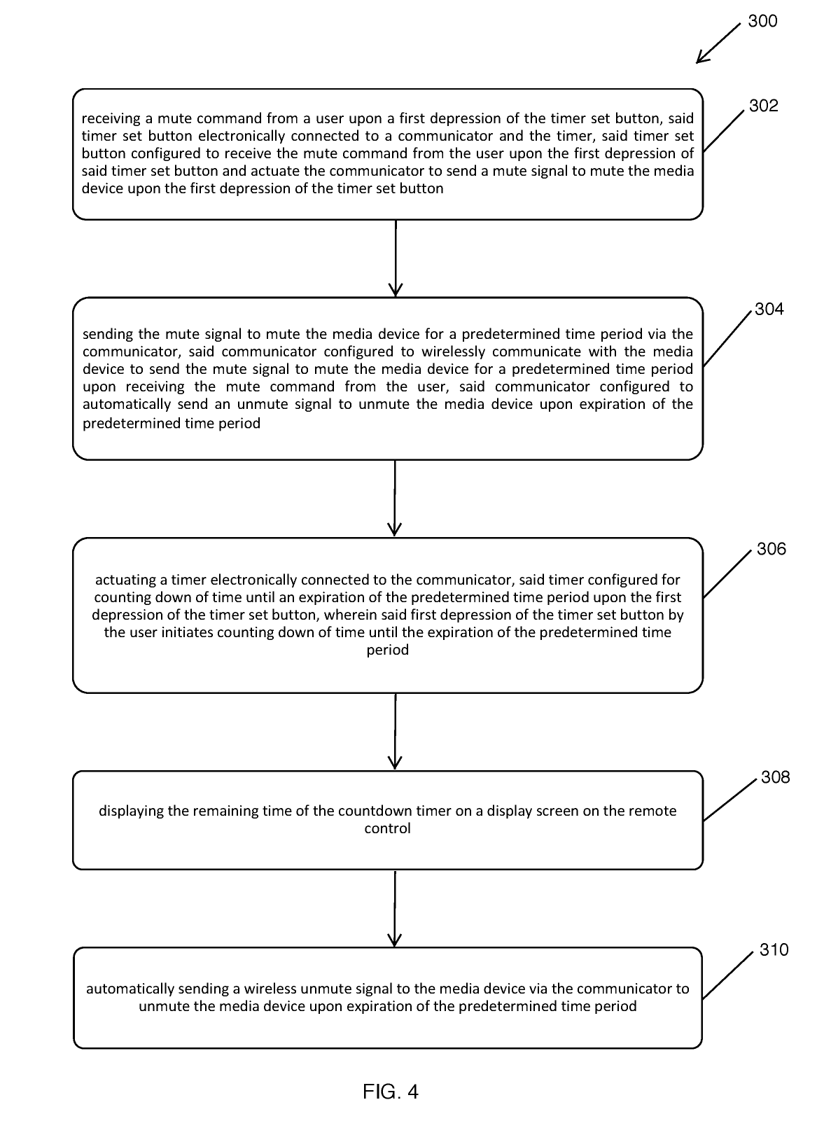

Referring to FIG. 4, a flow chart 300 shows an exemplary method for temporarily muting a media device with a remote control device comprising a timer and a timer set button, in accordance with embodiments disclosed herein. At step 302, the method includes receiving a mute command from a user upon a first depression of the timer set button, where the timer set button is electronically connected to a communicator and the timer, and the timer set button is configured to receive the mute command from the user upon the first depression of the timer set button and actuate the communicator to send a mute signal to mute the media device upon the first depression of the timer set button. Preferably, at step 304, the method includes sending the mute signal to mute the media device for a predetermined time period via the communicator, where the communicator is configured to wirelessly communicate with the media device to send the mute signal to mute the media device for a predetermined time period upon receiving the mute command from the user, and where the communicator is configured to automatically send an unmute signal to unmute the media device upon expiration of the predetermined time period.

At step 306, the method preferably includes actuating a timer electronically connected to the communicator, where the timer is configured for counting down of time until an expiration of the predetermined time period upon the first depression of the timer set button, wherein the first depression of the timer set button by the user initiates counting down of time until the expiration of the predetermined time period. At step 308, the method includes displaying the remaining time of the countdown timer on a display screen on the remote control. At step 310, the method includes automatically sending a wireless unmute signal to the media device via the communicator to unmute the media device upon expiration of the predetermined time period.

The invention disclosed herein provides multiple advantages over the prior art. For example, the novel integration of a countdown timer 116, display screen 120, processor 138, circuit board 140, and timer set button 118 combination into a remote control 100 allows the device to send commands to a media device, such as a TV or other compatible equipment such as HVAC, at some time in the future. For example, a timer 116 in a TV remote control may be able to set the time in increments, other than one second, one minute, or one hour, that may be preset or selectively determined by the user 112.

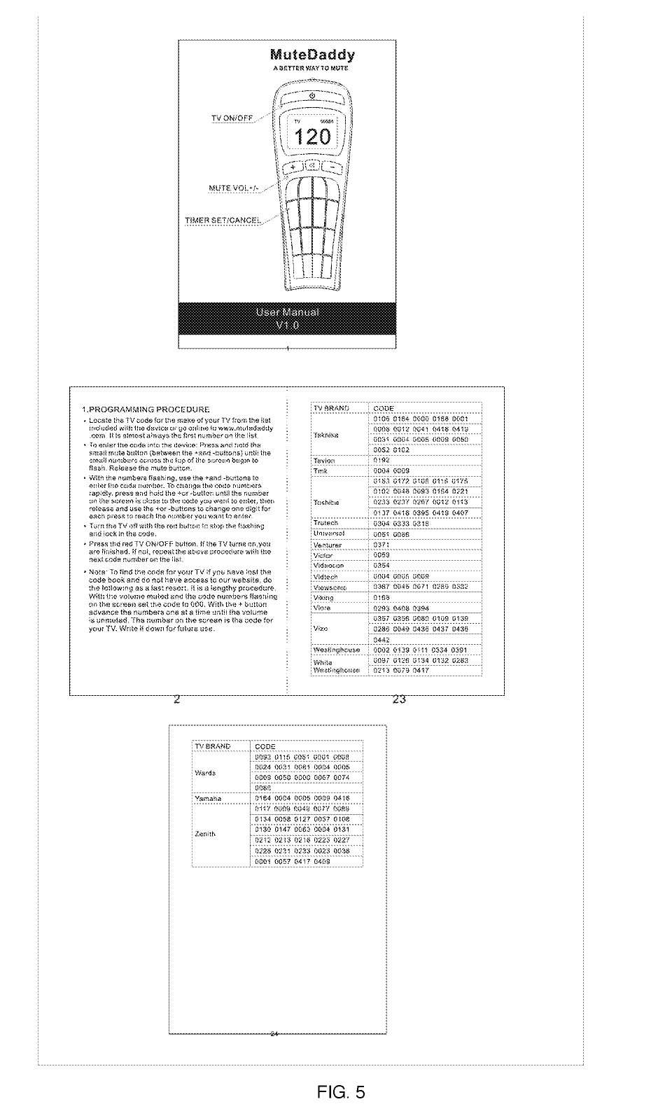

Referring to FIG. 5, an exemplary instruction manual is provided illustrating use of the device in accordance with embodiments of the invention.

All U.S. patents and publications identified herein are incorporated in their entirety by reference thereto.

This invention is susceptible to considerable variation within the spirit and scope of the appended claims.

The claimed invention is:

1. A television remote control device, comprising:
a communicator configured to wirelessly communicate with a media device, said communicator configured to send a mute signal to mute the media device for a predetermined time period upon receiving a mute command from a user, said communicator configured to send an unmute signal to unmute the media device upon expiration of the predetermined time period;
a timer electronically connected to the communicator, the timer configured for counting down of time until an expiration of the predetermined time period;
a timer set button electronically connected to the communicator and timer, said timer set button configured to receive the mute command from the user upon a first depression of said timer set button and actuate the communicator to send the mute signal to mute the media device upon the first depression of the timer set button, wherein said first depression of the timer set button initiates counting down of time until the expiration of the predetermined time period, wherein said expiration actuates the communicator to send the unmute signal to unmute the media device upon the expiration of the predetermined time period; and
a display screen configured to display the counting down of time of the predetermined period.

2. The remote control of claim 1, further comprising volume control buttons.

3. The remote control of claim 1, further comprising a power button configured to turn the media device on and off.

4. The remote control of claim 1, wherein the media device is a television.

5. The remote control of claim 1, wherein the media device is a home entertainment system.

6. The method of claim 1, wherein the wireless communication is infrared.

7. The method of claim 1, wherein the wireless communication is radio frequency.

8. A method for temporarily muting a media device with a remote control device comprising a timer and a timer set button, comprising:
receiving a mute command from a user upon a first depression of the timer set button, said timer set button electronically connected to a communicator and the timer, said timer set button configured to receive the mute command from the user upon the first depression of said timer set button and actuate the communicator to send a mute signal to mute the media device upon the first depression of the timer set button;
sending the mute signal to mute the media device for a predetermined time period via the communicator, said communicator configured to wirelessly communicate with the media device to send the mute signal to mute the media device for a predetermined time period upon receiving the mute command from the user, said communicator configured to automatically send an unmute signal to unmute the media device upon expiration of the predetermined time period;
actuating a timer electronically connected to the communicator, said timer configured for counting down of time until an expiration of the predetermined time period upon the first depression of the timer set button, wherein said first depression of the timer set button by the user initiates counting down of time until the expiration of the predetermined time period;
displaying the remaining time of the countdown timer on a display screen on the remote control; and
automatically sending a wireless unmute signal to the media device via the communicator to unmute the media device upon expiration of the predetermined time period.

9. The method of claim 8, wherein the predetermined time period is 30 seconds.

10. The method of claim 8, wherein the predetermined time period is 60 seconds.

11. The method of claim 8, wherein the predetermined time period is 90 seconds.

12. The method of claim 8, further comprising receiving a mute command from the user upon a second depression of the timer set button within one second of the first depression, wherein the second depression doubles the predetermined time period.

13. The method of claim 12, further comprising receiving a mute command from the user upon a third depression of the timer set button within one second of the second depression, wherein the third depression triples the predetermined time period.

14. The method of claim 8, further comprising receiving a second depression of the timer set button more than one second of time after an initiation of the predetermined time period interrupts the predetermined time period and automatically actuates the communicator to send a unmute signal to the media device to unmute the device.

15. The method of claim 8, wherein the wireless communication is infrared.

16. The method of claim 8, wherein the wireless communication is radio frequency.
